(19) United States
(12) Patent Application Publication
(10) Pub. No.: US 2023/0152802 A1
(43) Pub. Date: May 18, 2023

(54) POSITION ESTIMATION DEVICE, POSITION ESTIMATION METHOD, AND AUTONOMOUS DRIVING SYSTEM

(71) Applicant: Mitsubishi Electric Corporation, Tokyo (JP)

(72) Inventors: Naoki Takahashi, Tokyo (JP); Nariaki Takehara, Tokyo (JP); Kohei Mori, Tokyo (JP); Hiroki Fujiyoshi, Tokyo (JP)

(73) Assignee: Mitsubishi Electric Corporation, Tokyo (JP)

(21) Appl. No.: 17/851,482

(22) Filed: Jun. 28, 2022

(30) Foreign Application Priority Data
Nov. 17, 2021 (JP) 2021-186899

(51) Int. Cl. G05D 1/00; G01C 21/20

(52) U.S. Cl. CPC G05D 1/0088; G01C 21/20; G05D 2201/0213

(57) ABSTRACT

A position estimation device of the present disclosure includes: a communication-method-based reception unit which receives signals transmitted in respective communication methods, by reception units corresponding to the communication methods; an own position calculation unit which calculates first position information of the mobile body per calculation cycle, using the transmitted signal; a movement amount calculation unit which calculates a movement amount of the mobile body per the calculation cycle; an autonomous navigation positioning unit which calculates second position information on the basis of the first position information calculated by the own position calculation unit and the movement amount calculated by the movement amount calculation unit, for each communication method; and an index value calculation unit which calculates, for each communication method, a variance value of difference values between the first position information and the second position information, as an index value.

### BACKGROUND OF THE INVENTION

### 1. Field of the Invention

The present disclosure relates to a position estimation device, a position estimation method, and an autonomous driving system.

### 2. Description of the Background Art

In order to achieve autonomous driving for a mobile body, it is necessary to always recognize the own position of the mobile body accurately. As a method for estimating the own position of the mobile body, for example, there is a method using a satellite signal in a case where the mobile body travels outdoors. In addition, in an environment where a satellite signal is hardly received such as indoors, for example, there is a method using signals from a plurality of beacon signal transmitters provided at roadsides and the like.

Among locations where the mobile body travels as described above, communication methods with which position information of the mobile body can be acquired are different. Therefore, in order to always achieve accurate positioning, technology for switching communication methods to be used for positioning as necessary at each location is required.

In a position detection system described in Patent Document 1, in positioning the own position of a mobile body, positioning using a satellite signal is performed outdoors and positioning using a beacon signal is performed indoors, thus enabling the own position of the mobile body to be assuredly detected indoors and outdoors.

In a communication control system described in Patent Document 2, a communication method associated with a location where a mobile body is present is preferentially used, thus enabling switching to an appropriate communication method and achieving continuation of communication.
Patent Document 1: Japanese Laid-Open Patent Publication No. 2019-132627
Patent Document 2: Japanese Patent No. 5966291

The position detection system described in Patent Document 1 is set in advance such that, in a case where the own position can be positioned with both positioning systems of a satellite type and a beacon type, the beacon positioning system is used. Therefore, there is a problem that, in some cases, a positioning result of the satellite positioning system which is more accurate than the beacon positioning system cannot be used. That is, a problem is to make it possible to use a positioning result of the satellite positioning system when the positioning result of the satellite positioning system is more accurate than that of the beacon positioning system.

In the communication control system described in Patent Document 2, a communication method associated with a location where a mobile body is present is preferentially used. Therefore, there is a problem that, even if there is a communication method capable of more accurate positioning, a positioning result thereof cannot be used. That is, a problem is to make it possible to use a communication method having highest positioning accuracy at each location.

### SUMMARY OF THE INVENTION

The present disclosure has been made to solve the above problem, and an object of the present disclosure is to provide a position estimation device and a position estimation method for estimating the own position of a mobile body with high accuracy, and an autonomous driving system having high stability with use of the position estimation device.

A position estimation device according to the present disclosure is a position estimation device which is provided to a mobile body and estimates position information of the mobile body, the position estimation device including: a communication-method-based reception unit which receives signals transmitted respectively in a plurality of communication methods, by a plurality of reception units corresponding to the respective communication methods; an own position calculation unit which calculates first position information of the mobile body per calculation cycle, using the signal transmitted in each of the plurality of communication methods; a movement amount calculation unit which calculates a movement amount of the mobile body per the calculation cycle; an autonomous navigation positioning unit which calculates, for each of the plurality of communication methods, second position information of the mobile body on the basis of the first position information calculated by the own position calculation unit and the movement amount of the mobile body calculated by the movement amount calculation unit; and an index value calculation unit which calculates, for each of the plurality of communication methods, a variance value of difference values between the first position information and the second position information, as an index value.

An autonomous driving system according to the present disclosure includes: the above position estimation device which calculates position information of an own vehicle on the basis of signals transmitted respectively in a plurality of communication methods; a traveling route generation device which generates a traveling route for the own vehicle to reach a target location from the own-vehicle position, using the position information of the own vehicle outputted from the position estimation device; and a vehicle control device which sets a target track and a target vehicle speed for executing autonomous driving control for the own vehicle on the generated traveling route.

A position estimation method according to the present disclosure is a position estimation method for estimating position information of a mobile body, the method including: a communication-method-based reception step of receiving signals transmitted respectively in a plurality of communication methods, by a plurality of reception units corresponding to the respective communication methods; an own position calculation step of calculating first position information of the mobile body per calculation cycle, using the signal transmitted in each of the plurality of communication methods; a movement amount calculation step of calculating a movement amount of the mobile body per the calculation cycle; an autonomous navigation positioning step of calculating, for each of the plurality of communication methods, second position information of the mobile body on the basis of the first position information calculated in the own position calculation step and the movement amount of the mobile body calculated in the movement amount calculation step; and an index value calculation step of calculating, for each of the plurality of communication methods, a variance value of difference values between the first position information and the second position information, as an index value.

In the position estimation device according to the present disclosure, position information by a communication method for which the output priority determined on the basis of the index value is highest is selected from position information of the mobile body calculated by a plurality of communication methods, whereby it becomes possible to calculate position information of the mobile body on the basis of an optimum communication method among the plurality of communication methods, thus providing an effect of obtaining a position estimation device capable of outputting position information with high accuracy.

In the position estimation method according to the present disclosure, position information by a communication method for which the output priority determined on the basis of the index value is highest is selected from position information of the mobile body calculated by a plurality of communication methods, whereby it becomes possible to calculate position information of the mobile body on the basis of an optimum communication method among the plurality of communication methods, thus providing an effect of obtaining a position estimation method capable of calculating position information with high accuracy.

In the autonomous driving system according to the present disclosure, position information of the own-vehicle position can be calculated with high accuracy using the above position estimation device, thus providing an effect of obtaining an autonomous driving system that can achieve autonomous driving control having high stability on the basis of accurate position information.

### BRIEF DESCRIPTION OF THE DRAWINGS

FIG. 1 schematically shows a situation in which a position estimation device according to the first embodiment of the present disclosure is used;

FIG. 2 is a function block diagram showing the configuration of the position estimation device according to the first embodiment;

FIG. 3 is a schematic diagram of a processing circuit in the position estimation device according to the first embodiment;

FIG. 4 is a flowchart showing a position estimation method according to the first embodiment;

FIG. 5 is a flowchart showing a position estimation method according to the second embodiment of the present disclosure;

FIG. 6 is a function block diagram showing the configuration of a position estimation device according to the third embodiment of the present disclosure;

FIG. 7 is a flowchart showing a position estimation method according to the third embodiment;

FIG. 8 is a function block diagram showing the configuration of an autonomous driving system according to the seventh embodiment of the present disclosure;

FIG. 9 schematically shows a vehicle provided with the autonomous driving system according to the seventh embodiment;

FIG. 10 shows a hardware configuration for implementing the position estimation devices according to the first and third embodiments; and

FIG. 11 shows a hardware configuration for implementing the position estimation devices according to the first and third embodiments.

### DETAILED DESCRIPTION OF THE PREFERRED EMBODIMENTS OF THE INVENTION

### First Embodiment

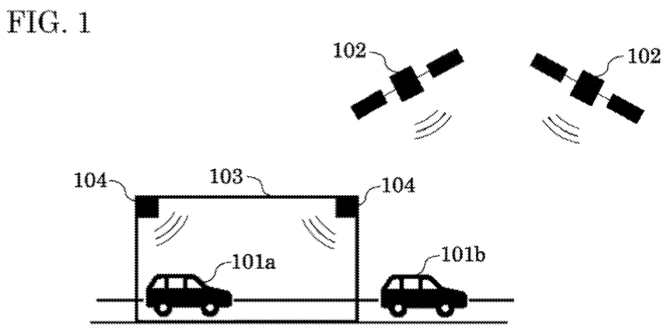

FIG. 1 schematically shows a situation in which a position estimation device 200 according to the first embodiment of the present disclosure is used. In FIG. 1, a vehicle 101a and a vehicle 101b which axe examples of mobile bodies are each provided with the position estimation device 200 according to the first embodiment. The vehicle 101a is inside a construction 103, and the vehicle 101b is outside the construction 103. A satellite signal transmitter 102 emits a radio signal toward the ground. A beacon signal transmitter 104 is provided in the construction 103. The beacon signal transmitter 104 is fixed to a wall of the construction 103. The vehicle 101a and the vehicle 101b each move indoors and outdoors while calculating own position information on the basis of a received satellite signal or beacon signal by using the position estimation device 200. Hereinafter, the vehicle 101a and the vehicle 101b may be collectively referred to as mobile bodies.

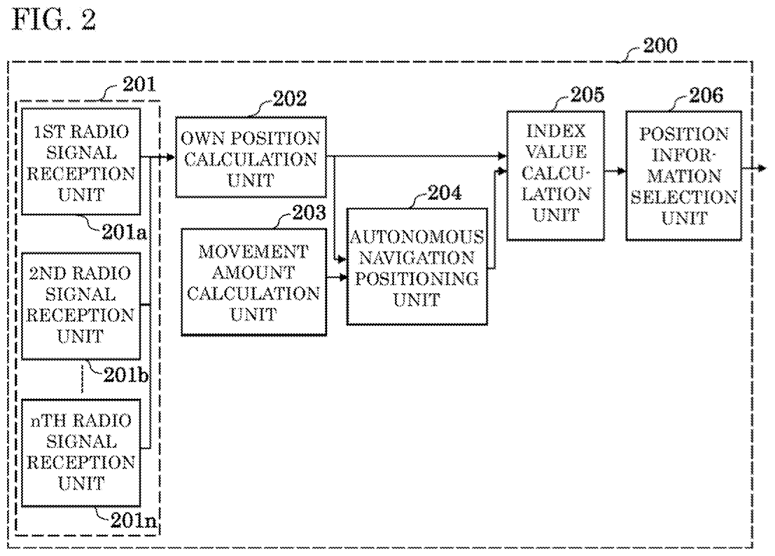

FIG. 2 is a function block diagram showing the configuration of the position estimation device 200 according to the first embodiment. The position estimation device 200 is provided to a mobile body such as a vehicle, for example. The position estimation device 200 according to the first embodiment includes a communication-method-based reception unit 201, an own position calculation unit 202, a movement amount calculation unit 203, an autonomous navigation positioning unit 204, an index value calculation unit 205, and a position information selection unit 206. The communication-method-based reception unit 201 includes a plurality of radio signal reception units corresponding to different communication methods, i.e., n radio signal reception units; a first radio signal reception unit 201a, a second radio signal reception unit 201b, . . . , an nth radio signal reception unit 201n.

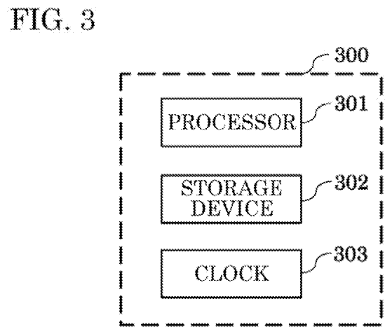

FIG. 3 is a schematic diagram of a processing circuit in the position estimation device 200 according to the first embodiment. Each function of the position estimation device 200 according to the first embodiment is implemented by a processing circuit 300 provided to the position estimation device 200.

The processing circuit 300 is composed of a processor 301, a storage device 302, and a clock 303, for example. In the storage device 302, software for implementing each function is written. Each function may be implemented by a plurality of processing circuits. In a case of having a plurality of processing circuits, the processing circuits communicate with each other using communication means such as a controller area network (CAN), to implement the functions of the position estimation device 200.

Hereinafter, the details of the functions of the position estimation device 200 according to the first embodiment will be described.

As described above, the communication-method-based reception unit 201 includes a plurality of radio signal reception units respectively corresponding to a plurality of communication methods, i.e., the first radio signal reception unit 201a, the second radio signal reception unit 201b, . . . , the nth radio signal reception unit 201n. In the function block diagram of the position estimation device 200 shown in FIG. 2, the number of the radio signal reception units is n. A radio signal emitted from a transmitter based on each communication method is received by the radio signal reception unit corresponding to that communication method.

Examples of the plurality of communication methods include code division multiple access (CDMA) and impulse-radio ultra wide band (IR-UWB). In the position estimation device 200 according to the first embodiment, COMA is used as satellite communication and IF-UWE is used as beacon communication. However, as long as the object of the present disclosure can be achieved, the communication methods are not limited to the above ones.

In order to calculate position information of a mobile body on the basis of a radio signal emitted from a transmitter using each communication method, the communication-method-based reception unit 201 performs distance measurement and angle measurement between the transmitter and the radio signal reception unit. Specific examples of a distance measurement method include a time of flight (ToF) method and a received signal strength indicator (RSSI) method.

Specific examples of an angle measurement method include an angle of arrival. (AoA) method and an angle of departure (AoD) method. In the position estimation device 200 according to the first embodiment, distance measurement by the ToF method is used. However, as long as the object of the present disclosure can be achieved, methods for distance measurement and angle measurement are not particularly limited.

The own position calculation unit 202 calculates position information of a mobile body, using signals respectively transmitted by a plurality of communication methods and received by the communication-method-based reception unit 201. The position information of the mobile body calculated by the own position calculation unit 202 may be referred to as first position information of the mobile body.

In a case of satellite communication, the position estimation device 200 according to the first embodiment derives an equation shown by the following Expression (1) having, as unknowns, position information (x, y, z) of the vehicle 101a and the vehicle 101b, and clock error t of the radio signal reception unit, using position information (xᵢ, yᵢ, zᵢ) of the satellite signal transmitter 102, a distance rᵢ from the satellite signal transmitter 102 to the communication-method-based reception unit 201, and the speed of light c, from the received signal.

[Mathematical 1]

\sqrt{(x−xᵢ)²+(y−yᵢ)²+(z−zᵢ)²}+t×c=rᵢ (1)

Expression (1) is derived for each received signal, and from four or more Expressions (1), the position information of the vehicle 101a and the vehicle 101b, i.e., the first position information of the vehicle 101a and the vehicle 101b, is calculated.

In the beacon communication method, the first position information of the vehicle 101a and the vehicle 101b is calculated on the basis of a trilateration principle, using distance information obtained from three or more received signals.

However, as long as the object of the present disclosure can be achieved, the calculation method for the position information of the mobile body is not particularly limited. For calculating the position information of the mobile body, different methods may be used depending on respective communication methods.

The movement amount calculation unit 203 acquires information from a sensor that can detect position information of a mobile body, and calculates a relative movement amount of the mobile body from a given location, on the basis of the information from the sensor. In the position estimation device 200 according to the first embodiment, the movement amount of the mobile body is calculated using time integral values of the acceleration and the angular velocity of the vehicle obtained from an inertia measurement device (not shown) provided to each of the vehicle 101a and the vehicle 101b. However, as long as the object of the present disclosure can be achieved, the sensor type and the calculation method for the movement amount of the mobile body are not particularly limited.

The movement amount of the mobile body calculated by the movement amount calculation unit 203 is stored in the storage device 302. Meanwhile, when a reset signal is transmitted from the autonomous navigation positioning unit 204 to the storage device 302, the movement amount of the mobile body stored in the storage device 302 is deleted.

The autonomous navigation positioning unit 204 calculates the absolute position of the mobile body at present, using the absolute position of the mobile body at a given location and the relative movement amount from the absolute position. The position information of the mobile body calculated by the autonomous navigation positioning unit 204 may be referred to as second position information of the mobile body. The absolute position of the mobile body is regularly acquired from the own position calculation unit 202. Here, regular acquisition means such a case of performing acquisition per calculation cycle, for example. The movement amount of the mobile body is acquired from the movement amount calculation unit 203.

The autonomous navigation positioning unit 204 acquires the position information of the mobile body from the own position calculation unit 202, i.e., the first position information, and at the same time, transmits a reset signal to the movement amount calculation unit 203. Thus, the movement amount of the mobile body calculated by the movement amount calculation unit 203 is treated as a movement amount from the absolute position acquired from the own position calculation unit 202.

The index value calculation unit 205 calculates an index value representing reliability of the position information of the mobile body calculated in each of the plurality of communication methods, using the first position information of the mobile body calculated by the own position calculation unit 202 and the second position information of the mobile body calculated by the autonomous navigation positioning unit 204.

The calculation method for the index value by the index value calculation unit 205 will be described. First, at the same time as a signal is received by the communication-method-based reception unit 201, the index value calculation unit 205 acquires the second position information of the mobile body calculated by the autonomous navigation positioning unit 204. After acquiring the second position information, the index value calculation unit 205 calculates a difference value between the first position information f rom the own position calculation unit 202 and the second position information from the autonomous navigation positioning unit 204. The calculated difference values for a certain number of times of sampling are stored in the storage device 302 in time series. The index value calculation unit 205 calculates a variance value from the stored difference values for the certain number of times of sampling, and uses the variance value as the index value. Here, the certain number of times of sampling means such a case of calculating the first position information and the second position information per calculation cycle through a predetermined number of consecutive calculation cycles.

On the basis of the index value, the position information selection unit. 206 imparts, to the first position information of the mobile body calculated in each communication method, an output priority for the position estimation device 200 to output the first position information, selects the first position information of the mobile body that is based on the communication method for which the output priority is highest, and outputs the selected first position information. That is, the position information selection unit 206 compares the index values for all the communication methods, and imparts a higher output priority in the ascending order of the index value.

The output of the position information selection unit 206 is transmitted to a vehicle control device of the mobile body described later, and the like, using communication means such as CAN. The position information selection unit 206 can perform output at a certain cycle in synchronization with the clock 303 of the processing circuit 300.

### Position Estimation Method According to the First Embodiment

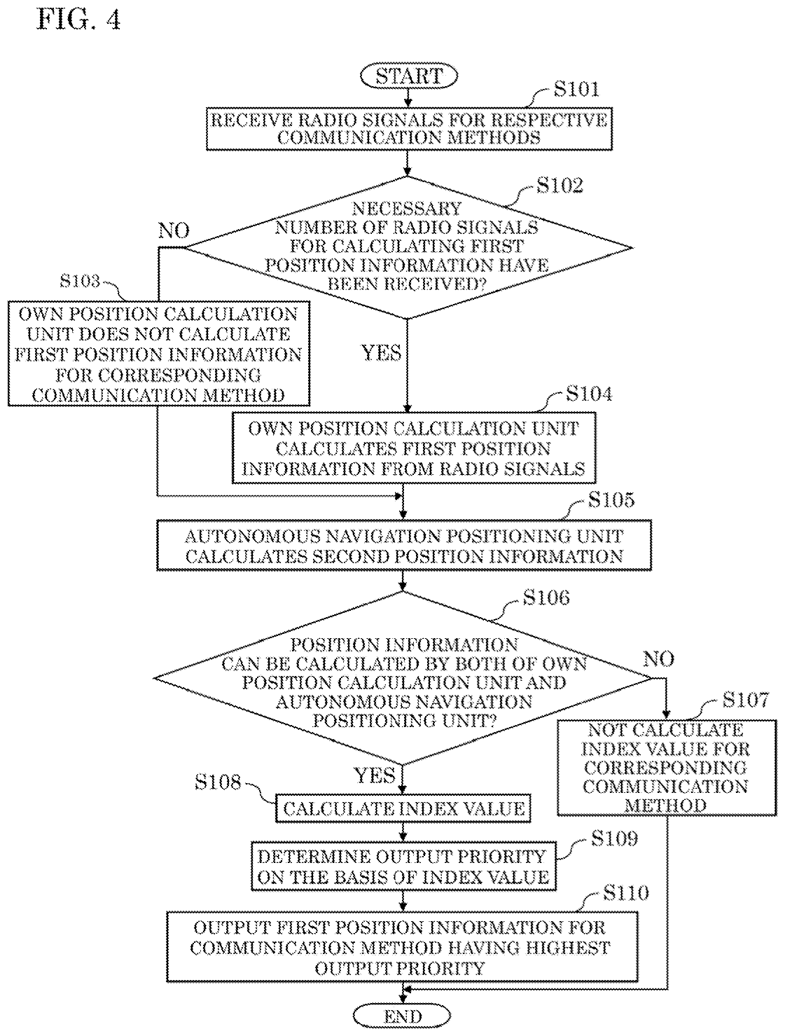

A position estimation method according to the first embodiment will be described with reference to a flowchart in FIG. 4. First, in step S101, the communication-method-based reception unit 201 receives radio signals from a plurality of transmitters for respective communication methods.

In the position estimation method according to the first embodiment, from the satellite signal transmitter 102, the following are received: distance information of the satellite signal transmitter 102, the position information of the satellite signal transmitter 102, clock error information between the satellite signal transmitter 102 and the communication-method-based reception unit 201, individual identification information of the satellite signal transmitter 102, and the like. From the beacon signal transmitter 104, the following are received: distance information of the beacon signal transmitter 104, individual identification information of the beacon signal transmitter 104, and the like.

In step S102, the communication-method-based reception unit 201 confirms whether or not a necessary number of radio signals for calculating the first position information of the mobile body have been received, for each of the plurality of communication methods. In the position estimation method according to the first embodiment, whether or not four or more signals have been received in a case of a satellite signal, or whether or not three or more signals have been received in a case of a beacon signal, is confirmed on the basis of identification information of each radio transmitter. In a case where the transmission frequencies of the satellite signal transmitter 102 and the beacon signal transmitter 104 are different from each other, reception confirmation is performed in accordance with each transmission frequency.

In step S102, if it is determined that a necessary number of radio signals for calculating the first position information of the mobile body have not been received for a given communication method, i.e., in the case of NO in step S102, in step S103, the own position calculation unit 202 does not perform calculation of the first position information of the mobile body for that communication method.

On the other hand, in step S102, if it is determined that a necessary number of radio signals for calculating the first position information of the mobile body have been received for a given communication method, i.e., in the case of YES in step S102, processing in step S104 is executed.

In step S104, the own position calculation unit 202 calculates the first position information of the mobile body using the radio signals. In the position estimation device 200 according to the first embodiment, for each of the vehicle 101a and the vehicle 101b which are mobile bodies, the first position information of the vehicle 101a and the vehicle 101b is calculated using satellite signals and beacon signals.

In a case of using satellite signals, four or more Expressions (1) are derived from four or more received signals, and then are solved as simultaneous equations, to calculate the first position information of the mobile body. On the other hand, in a case of using beacon signals, the first position information of the mobile body is calculated on the basis of a trilateration principle, using distance information obtained from three or more received signals. Calculation of the first position information of the mobile body may be repeatedly executed per calculation cycle.

In step S105, the autonomous navigation positioning unit 204 calculates the second position information of the mobile body.

In the position estimation method according to the first embodiment, the second position information of the vehicle 101a and the vehicle 101b is calculated using the absolute position (first position information) calculated from the satellite signals acquired in the past and the movement amount from the absolute position. The movement amount of the mobile body is calculated using time integral values of the acceleration and the angular velocity obtained from the inertia measurement device (not shown). In a case where the transmission frequencies of the satellite signal transmitter 102 and the beacon signal transmitter 104 are different from each other, at the same time as each sampling timing, the autonomous navigation positioning unit 204 executes calculation of the second position information of the mobile body.

In step S106, the index value calculation unit 205 determines whether or not the first position information and the second position information of the mobile body can be calculated by both of the own position calculation unit 202 and the autonomous navigation positioning unit 204. If one of the first position information and the second position information of the mobile body cannot be calculated, i.e., in the case of NO in step S106, the process proceeds to step S107. On the other hand, if the first position information and the second position information of the mobile body can be both calculated, i.e., in the case of YES in step S106, the process proceeds to step S108.

In step S107, the index value calculation unit 205 does not perform calculation of the index value for the corresponding communication method. After the processing in step S107, the process is ended.

In step S109, the index value calculation unit 205 calculates the index value, using the first position information of the mobile body from the own position calculation unit 202 and the second position information of the mobile body from the autonomous navigation positioning unit 204.

For the vehicle 101a which is an example of a mobile body in the first embodiment, as shown in FIG. 1, the construction 103 acts as a shielding object against satellite signals and thus the line-of-sight condition for the satellite signals is poor, so that noise mixing or multipath propagation is highly likely to occur. As a result, the first position information of the vehicle 101a calculated from the satellite signals is unstable and thus the index value calculated from the first position information becomes great.

On the other hand, for beacon signals transmitted from the beacon signal transmitter 104 provided in the construction 103, the line-of-sight condition to the vehicle 101a present in the same construction 103 is good. Therefore, the first position information of the vehicle 101a calculated from the beacon signals is stable and thus the index value calculated from the first position information becomes small.

Here, the line-of-sight condition means whether or not there is an obstacle between a transmitter and a receiver in radio communication. A good line-of-sight condition means that there are no obstacles between a transmitter and a receiver. On the other hand, a poor line-of-sight condition means that there is an obstacle between a transmitter and a receiver.

For the vehicle 101b which is an example of a mobile body in the first embodiment, such shielding objects against satellite signals are not present around the vehicle 101b. Therefore, the line-of-sight condition for satellite signals is good. As a result, the first position information of the vehicle 101b calculated from the satellite signals is stable and thus the index value calculated from the first position information of the vehicle 101b becomes small.

On the other hand, for the beacon signal transmitter 104 provided in the construction 103, the construction 103 acts as a shielding object against beacon signals. Therefore, the line-of-sight condition for beacon signals is poor for the vehicle 101b present outside the construction 103. In addition, the more distant the vehicle 101b is from the construction 103, the poorer the line-of-sight condition for beacon signals is. As a result, the first position information of the vehicle 101b calculated from the beacon signals is unstable and thus the index value calculated from the first position information of the vehicle 101b becomes great.

In step S109, the position information selection unit 206 imparts an output priority to the communication method for which the index value has been obtained. For the vehicle 101a which is an example of a mobile body in the first embodiment and is present inside the construction 103, the index value based on beacon signals is smaller than the index value based on satellite signals, and therefore the output priority for the first position information of the vehicle 101a calculated on the basis of beacon signals becomes higher.

On the other hand, for the vehicle 101b present outside the construction 103, the index value based on satellite signals is smaller than the index value based on beacon signals, and therefore the output priority for the first position information of the vehicle 101b calculated on the basis of satellite signals becomes higher.

In step S110, the position information selection unit 206 selects the first position information of the mobile body that is based on the communication method for which the output priority is highest, and outputs the selected first position information. For the vehicle 101a in the first embodiment, the output priority of the beacon communication is highest, and therefore the first position information of the vehicle 101a calculated on the basis of the beacon signals is outputted. On the other hand, for the vehicle 101b, the output priority of the satellite communication is highest, and therefore the first position information of the vehicle 101b calculated on the basis of the satellite signals is outputted.

The position estimation method according to the first embodiment is as described above.

### Effects of First Embodiment

As described above, in the position estimation device and the position estimation method according to the first embodiment, output priorities are determined using index values, whereby it becomes possible to calculate position information of a mobile body at each location on the basis of an optimum communication method among a plurality of communication methods, thus providing an effect of obtaining a position estimation device and a position estimation method capable of outputting position information with high accuracy.

### Second Embodiment

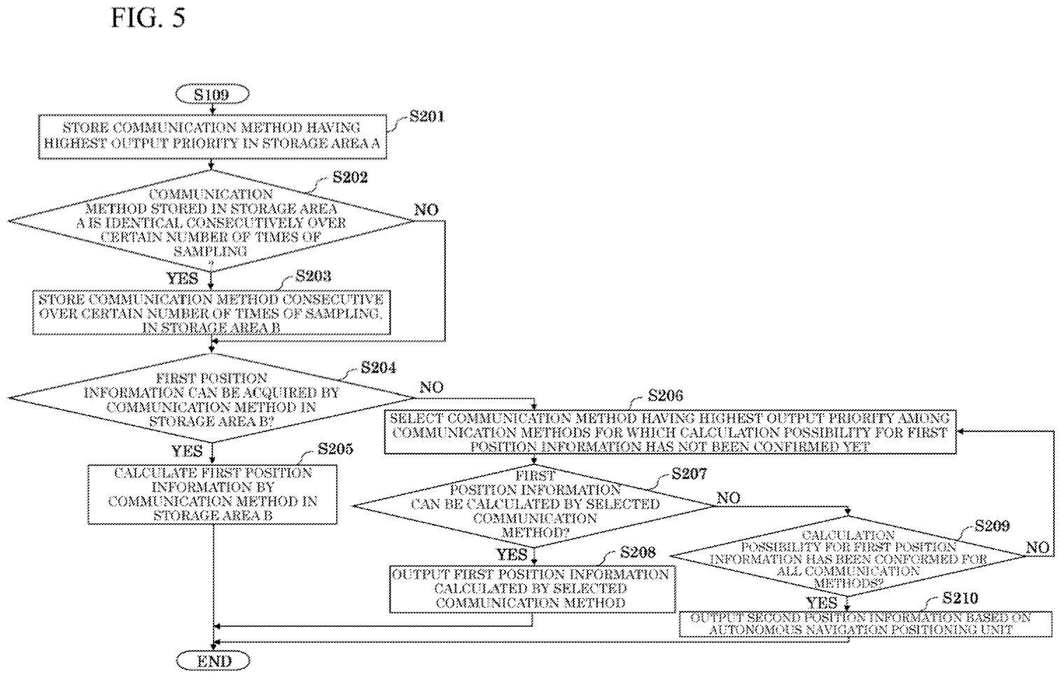

A position estimation method according to the second embodiment of the present disclosure will be described with reference to a flowchart in FIG. 5. Description of the same components as those in the above first embodiment is omitted.

In the position estimation method according to the first embodiment, first position information of a mobile body based on signals transmitted with a communication method for which the output priority is highest at each timing of sampling radio signals is selected. However, in such a situation that the output priorities frequently charge among communication methods, the communication method to be used for calculating the first position information of the mobile body is repeatedly switched. Under the situation in which the output priorities frequently change, if an offset occurs between respective first positions of the mobile body calculated on the basis of different communication methods, there is a possibility that the position information of the mobile body eventually outputted becomes unstable.

In the position estimation method according to the second embodiment, if the communication method for which the output priority is highest is identical over a predetermined number of consecutive calculation cycles, the first position information calculated by the communication method for which the output priority is highest is selected as position information of the mobile body. Therefore, by applying the position estimation method according to the second embodiment, the communication method to be used for calculating the position information of the mobile body can be prevented from being switched frequently, thus providing an effect of stabilizing the position information of the mobile body eventually outputted.

### Position Estimation Method According to Second Embodiment

Hereinafter, the position estimation method according to the second embodiment will be described. The flowchart shown in FIG. 5 is configured such that processing steps shown in FIG. 5 are added subsequent to the processing in step S109 in the flowchart shown in FIG. 4.

In step S201, the position information selection unit 206 stores the communication method for which the output priority is highest, in time series over a predetermined number of consecutive calculation cycles, in a specific storage area of the storage device 302. Here, the specific storage area is defined as a storage area A. The predetermined number of consecutive calculation cycles means consecutive periods through a certain number of times of sampling.

In step s202, the position information selection unit 206 confirms whether or not the communication method stored in the storage area A is identical over the predetermined number of consecutive calculation cycles.

If the communication method stored in the storage area A is identical, i.e., in the case of YES in step S202, the process proceeds to step s203. On the other hand, if the communication methods stored in the storage area A include communication methods that are not identical, i.e., in the case of NO in step S202, the process proceeds to step S204.

In step S203, the position information selection unit 206 stores the identical communication method stored in the storage area A, into another specific storage area of the storage device 302. Here, the other specific storage area is defined as a storage area B.

In step S204, the position information selection unit 206 determines whether or not the first position information of the mobile body can be calculated in the present calculation cycle using signals transmitted by the communication method stored in storage area B. If the first position information of the mobile body can be calculated, i.e., in the case of YES in step S204, the process proceeds to step S205. On the other hand, if the first position information of the mobile body cannot be calculated, i.e., in the case of NO in step S204, the process proceeds to step S206.

In step S205, the own position calculation unit 202 calculates the first position information of the mobile body from signals transmitted by the communication method stored in the storage area B.

In step S206 which is executed in the case where the first position information of the mobile body cannot be calculated in step S204, the communication method for which the output priority is highest is selected from the communication methods for which whether or not the first position information of the mobile body can be calculated has not been confirmed yet, and then the process proceeds to step S207.

In step S207, the position information selection unit 206 determines whether or not the first position information of the mobile body in the present calculation cycle can be calculated from signals transmitted by the selected communication method. If the first position information of the mobile body can be calculated, i.e., in the case of YES in step S207, the process proceeds to step S208. On the other hand, if the first position information of the mobile body cannot be calculated, i.e., in the case of NO in step S207, the process proceeds to step S209.

In step S208 which is executed in the case where the first position information of the mobile body can be calculated in step S207, the position information selection unit 206 outputs the first position information of the mobile body calculated from the signals transmitted by the selected communication method.

In step S209 which is executed in the case where the first position information of the mobile body cannot be calculated in step S207, the position information selection unit 206 determines whether or not all the communication methods have been confirmed regarding whether or not the first position information of the mobile body can be calculated. If confirmation has not been done for all the communication methods, i.e., in the case of NO in step S209, the position information selection unit 206 performs processing from step S206 again. On the other hand, if whether or not the first position information of the mobile body has been confirmed for all the communication methods, i.e., in the case of YES in step S209, the process proceeds to step S210.

In step S210, the position information selection unit 206 outputs the second position information of the mobile body acquired by the autonomous navigation positioning unit 204.

The position estimation method according to the second embodiment is as described above.

Regarding the position estimation method according to the second embodiment, a specific processing content will be described in a case where the vehicle 101a moves from the position in FIG. 1 to the position of the vehicle 101b, as art example.

At the initial stage when the vehicle 101a starts to move from the position in FIG. 1, the vehicle 101a is present inside the construction 103. Therefore, the line-of-sight condition for the satellite signal transmitter 102 is poor, whereas the line-of-sight condition is good for beacon signals transmitted from the beacon signal transmitter 104 provided in the construction 103. Thus, the output priority for beacon communication is high consecutively over a certain period, so that, in step S201, beacon communication is stored in time series in the storage area A.

Since beacon communication is stored in the storage area A consecutively over a certain period, i.e., a certain number of consecutive calculation cycles, in step S203, beacon communication is stored in the storage area B.

In step S204, the position information selection unit 206 refers to the communication method in the storage area B, to confirm whether or not the first position information of the vehicle 101a at present, i.e., in the present calculation cycle, can be calculated using beacon signals. If the first position information can be calculated, in step S205, the position information selection unit 206 outputs the first position information of the vehicle 101a calculated using the beacon signals.

As the vehicle 101a moves from the position in FIG. 1 frontward (rightward in FIG. 1), the line-of-sight condition for satellite signals transmitted from the satellite signal transmitter 102 is gradually improved. In this case, in such a transient period, while the first position information of the vehicle 101a can be calculated using beacon signals, the output priority frequently changes between satellite communication and beacon communication.

However, if the position estimation method according to the second embodiment is applied, by the processing in step S205, it becomes possible to continue outputting the first position information of the vehicle 101a calculated using beacon signals, even in such a situation that the output priority frequently changes between satellite signals and beacon signals. Thus, it becomes possible to prevent such a phenomenon that the position information of the vehicle 101a becomes unstable, i.e., the position accuracy is reduced, due to an offset of the first position information of the vehicle 101a caused in a case of performing calculation using both satellite signals and beacon signals.

If the first position information of the vehicle 101a at present, i.e., in the present calculation cycle, cannot be calculated using beacon signals, in step S207, whether or not the first position information of the vehicle 101a can be calculated using satellite signals is confirmed. If the first position information of the vehicle 101a can be calculated using satellite signals, in step S208, the position information selection unit 206 outputs the first position information of the vehicle 101a calculated using satellite signals.

By the above processing steps in the position estimation method according to the second embodiment, even in a case where a timing when the first position information of the vehicle 101a cannot be calculated using the communication method stored in storage area B, i.e., a calculation cycle in which the first position information of the vehicle 101a cannot be calculated, arises, the position estimation device 200 can always output either the first position information or the second position information, which is the position information of the vehicle 101a.

If the first position information of the vehicle 101a cannot be calculated using satellite signals, in step S210, using the past first position information of the vehicle 101a calculated from the past beacon signals and the movement amount of the mobile body obtained from the inertia measurement device, the second position information of the vehicle 101a at present, i.e., in the present calculation cycle, is calculated and outputted. The aforementioned past means the calculation cycle preceding the present calculation cycle by one cycle in the consecutive calculation cycles. However, the past may mean the calculation cycle more than one cycle ago.

### Effects of Second Embodiment

As described above, in the position estimation method according to the second embodiment, even in a case where a timing when the first position information of the mobile body cannot be calculated even by using any of the radio communication methods arises, the first position information or the second position information, which is the position information of the mobile body can be always outputted, thus providing an effect that the position information of the mobile body can be stably outputted with high accuracy.

### Third Embodiment

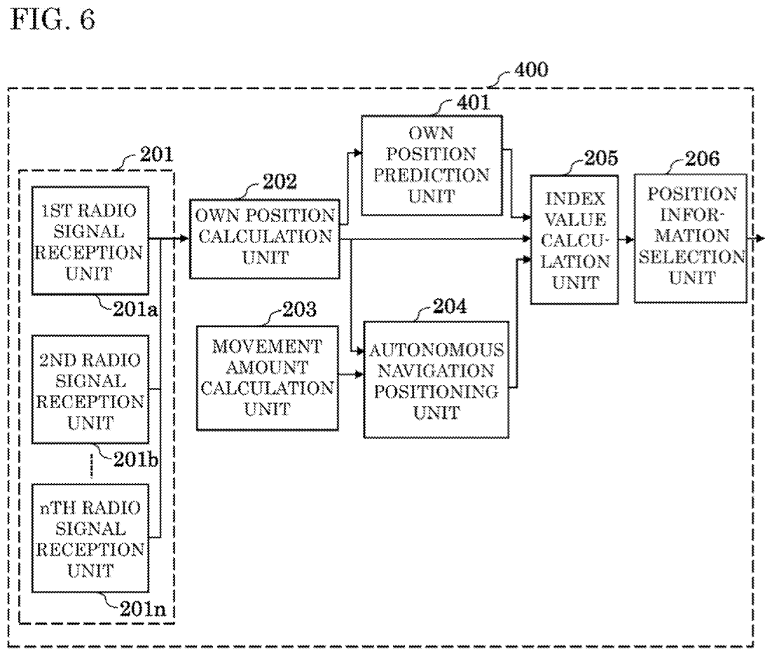

FIG. 6 is a function block diagram showing the configuration of a position estimation device 400 according to the third embodiment of the present disclosure. The position estimation device 400 according to the third embodiment is characterized by predicting position information of the mobile body. Description of the same components as those in the position estimation device 200 according to the above first embodiment is omitted.

The position estimation device 400 according to the third embodiment is configured by further providing an own position prediction unit 401 to the configuration of the position estimation device 200 according to the first embodiment.

The own position prediction unit 401 calculates a prediction value fox position information of a mobile body, using the first position information calculated by the own position calculation unit 202. In a position estimation method according to the third embodiment, an approximate function is calculated by linear approximation using the first position information for the past several times of sampling, and a prediction value is obtained from a value on the approximate function. However, as long as the object of the present disclosure can be achieved, the calculation method for the prediction value is not particularly limited. The calculation method for the prediction value may be different among communication methods. Calculation of the prediction value is performed for each communication method. In the processing after the index value calculation unit 205, the position information of the mobile body predicted by the own position prediction unit 401 is treated as the first position information calculated by the own position calculation unit 202.

The position estimation method according to the third embodiment will be described with reference to a flowchart in FIG. 7. The flowchart in FIG. 7 corresponds to processing between step S101 and step S105 in the flowchart in FIG. 4 showing the position estimation method according to the first embodiment, and step S103 in the flowchart in FIG. 4 is replaced with step S301 in the flowchart in FIG. 7.

In step S102, if the communication-method-based reception unit 201 cannot receive a necessary number of radio signals for calculating the position information of the mobile body in a given calculation cycle, in step S301, the own position prediction unit 401 calculates a prediction value for the first position information of the mobile body, which is needed for the next calculation cycle.

In FIG. 1 showing a situation in which the position estimation device 400 and the position estimation method according to the third embodiment are used, if the first position information of the vehicle 101a cannot be calculated even by using satellite signals, a linear approximation function is calculated using the past first position information of the vehicle 101a calculated using satellite signals. The present time is substituted into the calculated linear approximation function, to obtain a prediction value for the present position information of the vehicle 101a. The past position information of the vehicle 101a calculated using satellite signals is read from the storage device 302. In the above description, the present means the present calculation cycle. The past means, for example, the calculation cycle preceding the present, i.e., the present calculation cycle, by one cycle, in the consecutive calculation cycles. However, the past may mean the calculation cycle more than one cycle ago.

In step S302, the own position calculation unit 202 or the own position prediction unit 401 stores the calculated first position information of the mobile body in the storage device 302. In the steps subsequent to step S105, the prediction value from the own position prediction unit 401 is treated as the first position information of the mobile body calculated by the own position calculation unit 202.

### Effects of Third Embodiment

As described above, in the position estimation device and the position estimation method according to the third embodiment, even in such a situation that the first position information of the mobile body cannot be calculated at present, i.e., in the present calculation cycle, a prediction value for the first position information of the mobile body, calculated by the own position prediction unit, is used in the next calculation cycle, thus providing an effect that the position information of the mobile body can be stably outputted with high accuracy.

### Fourth Embodiment

A position estimation method according to the fourth embodiment of the present disclosure is characterized as follows. It is noted that the configuration of the position estimation device is the same as the configuration of the position estimation device 200 according to the first embodiment shown in FIG. 2.

In the position estimation method according to the fourth embodiment, the index value calculation unit 205 shown in FIG. 2 calculates a position accuracy reduction ratio on the basis of the location of the transmitter for each of a plurality of communication methods, such as the location of the satellite signal transmitter 102 or the beacon signal transmitter 104, which transmits signals to the communication-method-based reception unit 201. As a calculation method for the position accuracy reduction ratio, a known method is used.

If there is a communication method for which the calculated position accuracy reduction ratio is equal to or greater than a position accuracy threshold among the plurality of communication methods, the index value calculation unit 205 gives information about the position accuracy reduction ratio for that communication method to the position information selection unit 206. The position information selection unit 206 excludes, from selection, such a communication method for which the position accuracy reduction ratio is equal to or greater than the position accuracy threshold, on the basis of the given information about the position accuracy reduction ratio for that communication method.

### Effects of Fourth Embodiment

As described above, in the position estimation method according to the fourth embodiment, the position accuracy reduction ratio is calculated on the basis of the location of the transmitter for each of a plurality of communication methods, and if the position accuracy reduction ratio is equal to or greater than the position accuracy threshold, the corresponding communication method is excluded from selection, thus providing an effect that the position information of the mobile body is obtained with higher accuracy.

### Fifth Embodiment

A position estimation method according to the fifth embodiment of the present disclosure is characterized as follows. It is noted that the configuration of the position estimation device is the same as the configuration of the position estimation device 200 according to the first embodiment shown in FIG. 2.

In the position estimation method according to the fifth embodiment, the number of mismatch bits in a preamble part of a signal received by the communication-method-based reception unit 201 is calculated for each of a plurality of communication methods, and if there is a communication method for which the calculated number of mismatch bits is equal to or greater than a bit threshold, the index value calculation unit 205 gives information about the number of mismatch bits for that communication method to the position information selection unit 206. The position information selection unit 206 excludes, from selection, such a communication method fox which the number of mismatch bits is equal to or greater than the bit threshold, on the basis of the given information about the number of mismatch bits for that communication method.

### Effects of Fifth Embodiment

As described above, in the position estimation method according to the fifth embodiment, the number of mismatch bits in a preamble part of a received signal is calculated for each of a plurality of communication methods, and if there is a communication method for which the calculated number of mismatch bits is equal to or greater than the bit threshold, that communication method is excluded from communication method selection, thus providing an effect that the position information of the mobile body is obtained with higher accuracy.

### Sixth Embodiment

A position estimation method according to the sixth embodiment of the present disclosure is characterized as follows. It is noted that the configuration of the position estimation device is the same as the configuration of the position estimation device 200 according to the first embodiment shown in FIG. 2.

In the position estimation method according to the sixth embodiment, in the communication-method-based reception unit 201, if a reception angle with respect to a radio signal transmitter can be calculated from a transmitted radio signal, a reception angle with respect to a radio signal transmitter is calculated for each communication method for which the calculation is possible.

If there is a communication method for which the reception angle with respect to the radio signal transmitter is equal to or smaller than the reception angle threshold, the index value calculation unit 205 gives information about the reception angle for that communication method to the position information selection unit 206. The position information selection unit 206 excludes, from selection, such a communication method for which the reception angle is equal to or smaller than the reception angle threshold, on the basis of the information about the reception angle for that communication method.

### Effects of Sixth Embodiment

As described above, in the position estimation method according to the sixth embodiment, a reception angle with respect to the radio signal transmitter is calculated for each of a plurality of communication methods, and if there is a communication method for which the calculated reception angle is equal to or smaller than the reception angle threshold, that communication method is excluded from communication method selection, thus providing an effect that the position information is obtained with higher accuracy.

### Seventh Embodiment

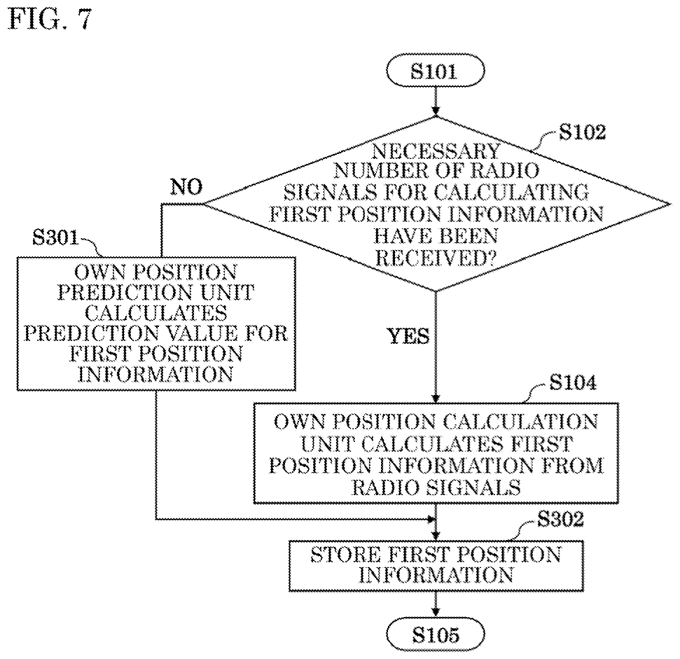

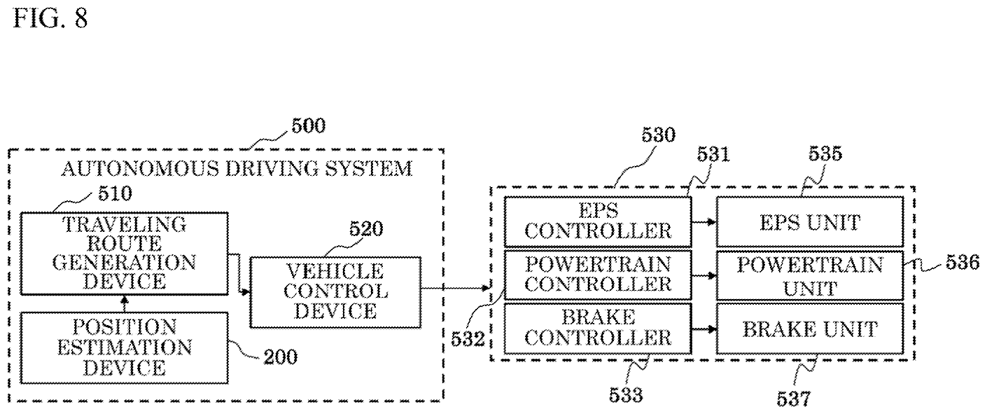

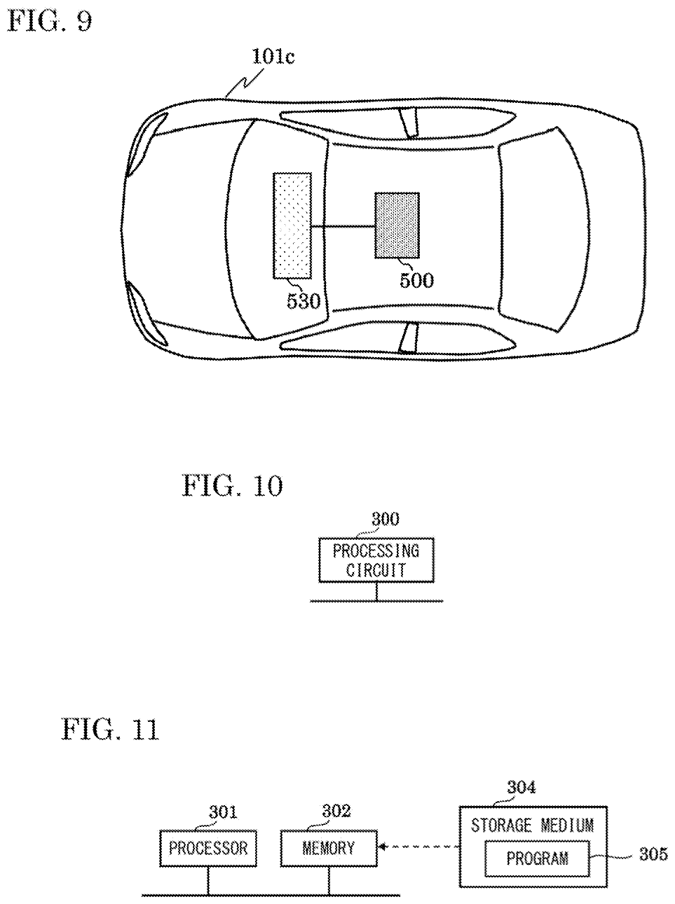

FIG. 8 is a function block diagram showing the configuration of an autonomous driving system 500 according to the seventh embodiment of the present disclosure. FIG. 9 schematically shows a vehicle 101c provided with the autonomous driving system 500 according to the seventh embodiment. The autonomous driving system 500 includes the position estimation device 200 according to the first embodiment, a traveling route generation device 510, and a vehicle control device 520.

As described above, the position estimation device 200 outputs either the first position information or the second position information, which is own-vehicle position information of the vehicle 101c, on the basis of signals transmitted by each of a plurality of communication methods. Instead of the position estimation device 200 according to the first embodiment, the position estimation device 400 according to the third embodiment may be used. The position estimation device 200 outputs the own-vehicle position information of the vehicle 101c to the traveling route generation device 510.

The traveling route generation device 510 generates a traveling route for the vehicle 101c to reach a target location from the own-vehicle position, using the own-vehicle position information of the vehicle 101c outputted from the position estimation device 200. For generation of the traveling route, a known method is applicable.

The vehicle control device 520 sets a target track and a target vehicle speed which are target control amounts needed for the vehicle 101c to travel on the traveling route generated by the traveling route generation device 510, and calculates a target steering amount and a target acceleration/deceleration needed for following the target track and the target vehicle speed. For calculation of the target steering amount and the target acceleration/deceleration, a known calculation method is applicable.

The configuration of the autonomous driving system 500 is as described above.

Hereinafter, vehicle control for the vehicle 101c by the autonomous driving system 500 will be described.

The target steering amount and the target acceleration/deceleration which are target control amounts, calculated in the vehicle control device 520 of the autonomous driving system 500, are outputted to an actuator 530, whereby autonomous driving control for the vehicle 101c is executed.

The actuator 530 includes an electronic power steering (EPS) controller 531, a powertrain controller 532, a brake controller 533, an EPS unit 535, a powertrain unit 536, and a brake unit 537.

The actuator 530 controls EPS, a brake, and an accelerator so as to cause the vehicle 101c to follow the target steering amount and the target acceleration/deceleration.

The EPS controller 531 controls the EPS unit 535 on the basis of the target steering amount outputted from the autonomous driving system 500. By the EPS controller 531, for example, a steering angle for the vehicle 101c to travel along the target track can be controlled.

The powertrain controller 532 controls the powertrain unit 536 so as to achieve the target acceleration/deceleration outputted from the autonomous driving system 500. In a case where a driver instead of autonomous driving control performs speed control, the powertrain unit 536 is controlled on the basis of the amount of tread on an accelerator pedal.

The brake controller 5:33 controls the brake unit 537 so as to achieve the target acceleration/deceleration outputted from the autonomous driving system 500. In a case where the driver instead of autonomous driving control performs speed control, the brake unit 537 is controlled on the basis of the amount of tread on a brake pedal.

### Effects of Seventh Embodiment

As described above, in the autonomous driving system according to the seventh embodiment, own-vehicle position information is calculated with high accuracy by the position estimation device 200, 400 according to the first or third embodiment, thus providing an effect that autonomous driving control having high stability can be achieved on the basis of accurate position information.

In the above description, the functions of the components of the position estimation devices 200, 400 according to the first and third embodiments and the autonomous driving system 500 according to the seventh embodiment are implemented by one of hardware and software, etc. However, without limitation thereto, some of the components of the position estimation devices 200, 400 according to the first and third embodiments and the autonomous driving system 500 according to the seventh embodiment may be implemented by dedicated hardware and the other components may be implemented by software, etc.

For example, as shown in FIG. 10 and FIG. 11, for some of the components, the functions thereof may be implemented by the processing circuit 300 as dedicated hardware, and for the other components, the processing circuit 300 as the processor 301 may read and execute a program for causing a computer or the like to execute the position estimation method according to any of the first to sixth embodiments stored in the storage device 302, thereby implementing the functions of the other components.

As shown in FIG. 11, setting data to be used in the function units and the like of the position estimation devices 200, 400 according to the first and third embodiments and the autonomous driving system 500 according to the seventh embodiment may be installed as a part of software to the storage device 302 from a storage medium 304 storing a program 305 for causing a computer or the like to execute the position estimation method according to any of the first to sixth embodiments.

As described above, the position estimation devices 200, 400 according to the first and third embodiments and the autonomous driving system 500 according to the seventh embodiment can implement the above-described functions by hardware, software, etc., or a combination thereof.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least ore of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

101a, 101b, 101c vehicle
102 satellite signal transmitter
103 construction
104 beacon signal transmitter
200, 400 position estimation device
201 communication-method-based reception unit
201a first radio signal reception unit
201b second radio signal reception unit
201n nth radio signal reception unit
202 own position calculation unit
203 movement amount calculation unit
204 autonomous navigation positioning unit
205 index value calculation unit
206 position information selection unit
300 processing circuit
301 processor
302 storage device
303 clock
304 storage medium
305 program
401 own position prediction unit
500 autonomous driving system
510 traveling route generation device
520 vehicle control device
530 actuator
531 EPS controller
532 powertrain controller
533 brake controller
535 EPS unit
536 powertrain unit
537 brake unit

What is claimed is:

1. A position estimation device which is provided to a mobile body and estimates position information of the mobile body, the position estimation device comprising at least one processor configured to implement:
a communication-method-based receiver which receives signals transmitted respectively in a plurality of communication methods, by a plurality of receivers corresponding to the respective communication methods;
an own position calculator which calculates first position information of the mobile body per calculation cycle, using the signal transmitted in each of the plurality of communication methods;
a movement amount calculator which calculates a movement amount of the mobile body per the calculation cycle;
an autonomous navigation positioning circuitry which calculates, for each of the plurality of communication methods, second position information of the mobile body on the basis of the first position information calculated by the own position calculator and the movement amount of the mobile body calculated by the movement amount calculator; and
an index value calculator which calculates, for each of the plurality of communication methods, a variance value of difference values between the first position information and the second position information, as an index value.

2. The position estimation device according to claim 1, further comprising a position information selector which determines, using the index value, an output priority for each of the plurality of communication methods, and selects the first position information calculated by the communication method for which the output priority is highest, as the position information of the mobile body.

3. The position estimation device according to claim 1, further comprising a position information selector which, if the communication method for which the output priority is highest is identical over a predetermined number of consecutive calculation cycles, selects the first position information calculated by the communication method for which the output priority is highest, as the position information of the mobile body.

4. The position estimation device according to claim 3, wherein
if calculation of the first position information by the communication method for which the output priority is highest is impossible, whether or not calculation of the first position information is possible is determined in a descending order of the output priority, and the first position information calculated by the communication method for which the output priority is highest among other communication methods by which calculation of the first position information is possible, is selected as the position information of the mobile body.

5. The position estimation device according to claim 2, further comprising an own position predictor which calculates a prediction value for the first position information in a next calculation cycle on the basis of the first position information calculated by the own position calculator, wherein
if there is a communication method by which calculation of the first position information is impossible in the next calculation cycle among the plurality of communication methods, the own position calculator uses the prediction value for the first position information calculated by the own position predictor, as the first position information in the next calculation cycle.

6. The position estimation device according to claim 2, wherein
in the index value calculator, a position accuracy reduction ratio is further calculated on the basis of a location of a transmitter that transmits a signal to the communication-method-based receiver for each of the plurality of communication methods, and
the position information selector excludes, from selection, the communication method for which the position accuracy reduction ratio is equal to or greater than a position accuracy threshold.

7. The position estimation device according to claim 2, wherein
in the communication-method-based receiver, a number of mismatch bits in a preamble part of a received signal is further calculated for each of the plurality of communication methods, and
the position information selector excludes, from selection, the communication method for which the number of mismatch bits is equal to or greater than a bit threshold.

8. The position estimation device according to claim 2, wherein
in the communication-method-based receiver, if calculation of a reception angle with respect to a radio signal transmitter is possible on the basis of a transmitted radio signal, the reception angle with respect to the radio signal transmitter is further calculated for each of the communication methods for which the calculation is possible, and
the position information selector excludes, from selection, the communication method for which the reception angle is equal to or smaller than a reception angle threshold.

9. The position estimation device according to claim 1, wherein
in the own position calculator, if calculation of the first position information is impossible for all the plurality of communication methods, the second position information calculated by the autonomous navigation positioning circuitry is used as the position information of the mobile body.

10. The position estimation device according to claim 3, further comprising an own position predictor which calculates a prediction value for the first position information in a next calculation cycle on the basis of the first position information calculated by the own position calculator, wherein
if there is a communication method by which calculation of the first position information is impossible in the next calculation cycle among the plurality of communication methods, the own position calculator uses the prediction value for the first position information calculated by the own position predictor, as the first position information in the next calculation cycle.

11. The position estimation device according to claim 3, wherein
in the index value calculator, a position accuracy reduction ratio is further calculated on the basis of a location of a transmitter that transmits a signal to the communication-method-based receiver for each of the plurality of communication methods, and
the position information selector excludes, from selection, the communication method for which the position accuracy reduction ratio is equal to or greater than a position accuracy threshold.

12. The position estimation device according to claim 3, wherein
in the communication-method-based receiver, a number of mismatch bits in a preamble part of a received signal is further calculated for each of the plurality of communication methods, and
the position information selector excludes, from selection, the communication method for which the number of mismatch bits is equal to or greater than a bit threshold.

13. The position estimation device according to claim 3, wherein
in the communication-method-based receiver, if calculation of a reception angle with respect to a radio signal transmitter is possible on the basis of a transmitted radio signal, the reception angle with respect to the radio signal transmitter is further calculated for each of the communication methods for which the calculation is possible, and
the position information selector excludes, from selection, the communication method for which the reception angle is equal to or smaller than a reception angle threshold.

14. The position estimation device according to claim 2, wherein
in the own position calculator, if calculation of the first position information is impossible for all the plurality of communication methods, the second position information calculated by the autonomous navigation positioning circuitry is used as the position information of the mobile body.

15. An autonomous driving system comprising:
the position estimation device according to claim 1, which calculates position information of an own vehicle on the basis of signals transmitted respectively in a plurality of communication methods;
a traveling route generation device which generates a traveling route for the own vehicle to reach a target location from the own-vehicle position, using the position information of the own vehicle outputted from the position estimation device; and
a vehicle control device which sets a target track and a target vehicle speed for executing autonomous driving control for the own vehicle on the generated traveling route.

16. A position estimation method for estimating position information of a mobile body, the method comprising:
receiving signals transmitted respectively in a plurality of communication methods, by a plurality of receiver corresponding to the respective communication methods;
calculating first position information of the mobile body per calculation cycle, using the signal transmitted in each of the plurality of communication methods;
calculating a movement amount of the mobile body per the calculation cycle;
positioning, for each of the plurality of communication methods, second position information of the mobile body on the basis of the first position information calculated in the own position calculating and the movement amount of the mobile body calculated in the movement amount calculating; and
calculating, for each of the plurality of communication methods, a variance value of difference values between the first position information and the second position information, as an index value.

17. The position estimation method according to claim 16, further comprising:
determining, using the index value, an output priority for each of the plurality of communication methods, and selecting the first position information calculated by the communication method for which the output priority is highest, as the position information of the mobile body.

18. The position estimation method according to claim 17, further comprising:
selecting, if the communication method for which the output priority is highest is identical over a predetermined number of consecutive calculation cycles, the first position information calculated by the communication method for which the output priority is highest, as the position information of the mobile body.

19. The position estimation method according to claim 18, wherein
if calculation of the first position information by the communication method for which the output priority is highest is impossible, whether or not calculation of the first position information is possible is determined in a descending order of the output priority, and the first position information calculated by the communication method for which the output priority is highest among other communication methods by which calculation of the first position information is possible, is selected as the position information of the mobile body.

20. The position estimation method according to claim 17, further comprising:
predicting by calculating a prediction value for the first position information in a next calculation cycle on the basis of the first position information calculated in the own position calculating, wherein
in the own position calculating, if there is a communication method by which calculation of the first position information is impossible in the next calculation cycle among the plurality of communication methods, the prediction value for the first position information calculated in the own position predicting is used as the first position information in the next calculation cycle.
